(19) United States
(12) Patent Application Publication
(10) Pub. No.: US 2021/0284553 A1
(43) Pub. Date: Sep. 16, 2021

(54) METHOD FOR SELECTIVE ABSORPTION OF LEAD IONS FROM HEAVY METAL WASTEWATER BY ELECTRIC FIELD ENHANCEMENT

(71) Applicant: Nanchang Hangkong University, Nanchang City (CN)

(72) Inventors: Xubiao Luo, Nanchang City (CN); Ziwen Chang, Nanchang City (CN); Liming Yang, Nanchang City (CN); Penghui Shao, Nanchang City (CN); Hui Shi, Nanchang City (CN); Genping Yi, Nanchang City (CN); Chenquan Ni, Nanchang City (CN)

(73) Assignee: Nanchang Hangkong University, Nanchang City (CN)

(21) Appl. No.: 17/081,733

(22) Filed: Oct. 27, 2020

(30) Foreign Application Priority Data
Mar. 11, 2020 (CN) 202010168123.1

(51) Int. Cl. C02F 1/469; C02F 1/467; C02F 1/28; C02F 1/461

(52) U.S. Cl. CPC C02F 1/469; C02F 1/4678; C02F 1/288; C02F 2101/20; C02F 1/283; C02F 1/285; C02F 1/46109

(57) ABSTRACT

A method for selective adsorption of lead ions from heavy metal wastewater by electric field enhancement relating to a method for recovering lead ions from heavy metal wastewater. The method aims to solve the technical problems that it is difficult to recover heavy metals from a complex water environment in well-targeted manner and recovery purity is poor because of poor selectivity of the existing adsorbents. The adsorption selectivity to Pb²⁺ is enhanced under an electric field by applying a tannic acid@graphene oxide conductive aerogel material to water heavy metal electrochemical adsorption system as a conductive adsorbent. In the method, the conductive layer of the tannic acid@graphene oxide conductive aerogel material may be optimized through electrochemical reduction, so that the material has better conductivity, and has better selectivity to lead ions under an electric field.

### CROSS-REFERENCE TO RELATED APPLICATIONS

This application claims the benefit of priority to Chinese Patent Application Serial No. CN 202010168123.1, which was filed on Mar. 11, 2020. The disclosure of the prior application is considered part of and hereby incorporated by reference in its entirety in the disclosure of this application.

### TECHNICAL FIELD

The invention relates to a method for recovery of lead ions from heavy metal wastewater.

### BACKGROUND

With the rapid development of industrialization, large amounts of pollutants are released into the aquatic environment, which poses serious environmental challenges worldwide. On the other hand, it is a major challenge to achieve sustainable development by selective recovery of heavy metal resources due to increasingly exhausted heavy metal resources. There are many symbiotic ions in the complex heavy metal polluted wastewater environment, so that it is difficult for selective recovery of heavy metal ions. The traditional methods for remediation of heavy metal polluted water bodies include chemical precipitation, electrocoagulation, membrane filtration, ion exchange and the like. However, these methods have disadvantages such as high cost, difficulty in regeneration and fouling in the activated-sludge process. Adsorption is considered to be one of the most efficient, simplest, and cost-optimal techniques. In general, conventional adsorbents, including activated carbon, clay, activated alumina and zeolite, have poor selectivity, which results in difficulty in recovery of heavy metals from complex aqueous environments in a well-targeted manner and poor recovery purity. Therefore, it is necessary to develop a new method to enhance the selectivity of adsorbents to heavy metal ions.

The heavy metal ions have different reduction potentials, and also they have different electrical mobility in the aqueous solution, that is different migration rates under the action of an electric field. Therefore, it is very feasible to apply the conductive adsorbent to the electrochemical system and adjust the selectivity of the adsorbent to heavy metal ions through the electric field. Tannic acid (TA), as a natural plant-derived polyphenol, is very common in various higher plants, and performs well in the adsorption of metal ions due to abundant functional groups, but their selectivity to heavy metal ions is unsatisfactory. Graphene oxide as a traditional adsorbent has good removal performance for heavy metal ions, and has excellent electrical conductivity under reduction conditions.

### SUMMARY

An embodiment of the present disclosure provides a method for selective adsorption of lead ions from heavy metal wastewater by electric field enhancement, aiming to solve the technical problem that it is difficult to recover heavy metals from a complex water environment in a well-targeted manner and recovery purity is poor because of poor selectivity of the existing adsorbents.

The method for selective adsorption of lead ions from heavy metal wastewater by electric field enhancement includes the following steps of:

in a first step (“step 1”), conducting an electroreduction process in a sodium nitrate electrolyte solution by a current-time method (I-t), with a three-electrode system composed of tannic acid@graphene oxide conductive aerogel as a working electrode, Ag/AgCl as a reference electrode and platinum mesh as a counter electrode, and obtaining tannic acid@reduced graphene oxide conductive aerogel; where an applied voltage is −1.2 V to −2 V, a reduction time is 2 min to 30 min, and a concentration of the sodium nitrate aqueous solution is 0.5 mol/L to 0.6 mol/L;

secondly, conducting an electrochemical adsorption in a lead ions-containing heavy metal wastewater electrolyte solution by a current-time method, with a three-electrode system composed of tannic acid@reduced graphene oxide conductive aerogel as a working electrode, Ag/AgCl as a reference electrode and platinum mesh as a counter electrode, and recovering lead element on the working electrode prepared in step 1, where a voltage is −0.1 V to −0.2 V, and an adsorption time is 2 h to 2.5 h.

According to one embodiment, the adsorption selectivity to Pb′ is enhanced under an electric field by applying the tannic acid@graphene oxide conductive aerogel material to waste water heavy metal electrochemical adsorption system as a conductive adsorbent. In the method, the conductive layer of the tannic acid@graphene oxide conductive aerogel material may be optimized through electrochemical reduction, so that the material has better conductivity, and has better selectivity to lead ions under an electric field.

In the invention, tannic acid and graphene oxide are cross-linked to prepare an aerogel material, which can not only retain the functional group of tannic acid, but also make the material have certain conductive properties. This allows the material to be applied to electrochemical systems to enhance the selectivity of the conductive adsorbent to heavy metal ions. The material has a good effect on adsorption of lead ions, and greatly enhances the selective adsorption of lead ions by applying a certain electric field force due to the excellent conductivity of the material, and achieves the selective recovery of lead ions by separating lead ions from other heavy metal ions in waste water. The method is green and environment-friendly, and has good application prospect for selective recovery of heavy metal ions from wastewater.

Various embodiments described herein not only can reduce the pollution of the water, but also can realize the selective recovery of metal resources.

### BRIEF DESCRIPTION OF THE DRAWING

FIG. 1 shows a scanning electron microscope (SEM) image of tannic acid@graphene oxide in a first (“step 1”) of a first experiment (“Experiment 1”);

FIG. 2 shows a graph of adsorption capacity data of tannic acid@graphene oxide conductive aerogel for each metal ion in a mixed ion solution under different electric field conditions in Experiment 1;

FIG. 3 shows a graph of selectivity coefficient data of tannic acid@graphene oxide conductive aerogel for lead over copper ions under different electric field conditions in Experiment 1;

FIG. 4 shows a graph of adsorption capacity data of tannic acid@graphene oxide conductive aerogel for heavy metal ions in different reduction states under an electric field of −0.2 V in a second experiment (“Experiment 2”);

FIG. 5 shows a graph of selectivity coefficient data of tannic acid@graphene oxide conductive aerogel for lead over copper ions in different reduction states at a voltage of −0.2 V in Experiment 2.

### DETAILED DESCRIPTION

Example 1: This Example is a method for selective adsorption of lead ions from heavy metal wastewater by electric field enhancement, which specifically includes the following steps:

firstly, an electroreduction process was conducted in a sodium nitrate electrolyte solution by a current-time method, with a three-electrode system composed of tannic acid@graphene oxide conductive aerogel as a working electrode, Ag/AgCl as a reference electrode, and platinum mesh as a counter electrode, and tannic acid@reduced graphene oxide conductive aerogel was obtained; where an applied voltage was −1.2 V to −2 V, a reduction time was 2 min to 30 min, and a concentration of the sodium nitrate aqueous solution was 0.5 mol/L to 0.6 mol/L;

secondly, an electrochemical adsorption was conducted in a lead ions-containing heavy metal wastewater electrolyte solution by a current-time method, with a three-electrode system composed of the tannic acid@reduced graphene oxide conductive aerogel prepared in step 1 as a working electrode, Ag/AgCl as a reference electrode, and platinum mesh as a counter electrode, and lead element on the working electrode was recovered, where a voltage was −0.1 V to −0.2 V, and an adsorption time was 2 h to 2.5 h.

Example 2: This Example differs from Example 1 in that: a preparation method of the tannic acid@graphene oxide conductive aerogel in step 1 includes the following steps:

2.5 mL of graphene oxide dispersion liquid was uniformly mixed with 1 mL of tannic acid aqueous solution, ultrasonic dispersion was conducted for 20 min, then 1.5 mL of deionized water was added, ultrasonic dispersion was conducted for 10 min, the mixture was put into an oven for incubation at 90° C. for 20 h, then taken out from the oven, and stood and soaked in deionized water, the deionized water was changed every 30 min for standing and soaking for 30 min until the aqueous solution changed from light yellow to colorless and transparent to wash off excess tannic acid, and finally the tannic acid@graphene oxide conductive aerogel was obtained by freeze-drying for 24 h;

where the graphene oxide dispersion liquid was purchased from Beijing J&K Scientific Ltd., with a concentration of 4 mg/mL, and a solvent of deionized water; and

a concentration of the tannic acid aqueous solution was 10 mg/mL. The others are the same as Example 1.

Example 3: This Example differs from Example 1 or 2 in that: an electrochemical workstation CHI760E was used for the electroreduction process by a current-time method in step 1. The others are the same as Example 1 or 2.

Example 4: This Example differs from Examples 1 to 3 in that: the applied voltage in step 1 was −1.2 V and the reduction time was 5 min. The others are the same as Examples 1 to 3.

Example 5: This Example differs from Example 4 in that: an electrochemical workstation CHI760E was used for the electrochemical adsorption by a current-time method in step 2. The others are the same as Example 4.

Example 6: This Example differs from Example 5 in that: in step 2, the voltage was −0.2 V and the adsorption time was 2 h. The others are the same as Example 5.

Various embodiments of the present disclosure were verified with the following experiments:

Experiment 1: the experiment verified the influence of tannic acid@graphene oxide conductive aerogel on adsorption selectivity of lead ions under different electric field intensity, including the following steps:

firstly, 15 mL of mixed ion solution was prepared in 5 copies; the mixed ion solution contained metal ions Pb²⁺, Cu²⁺, Cd²⁺, Co²⁺ and Ni²⁺, and a concentration of each metal ion was 1 mmol/L;

secondly, an electrochemical adsorption was conducted (with an electrochemical working station CHI760E from Shanghai CH Instruments Co., Ltd.) in a mixed ions electrolyte solution prepared in step 1 by a current-time method (I-t), with a three-electrode system composed of the tannic acid@reduced graphene oxide conductive aerogel as a working electrode (also served as an adsorbent), Ag/AgCl as a reference electrode and platinum mesh as a counter electrode, where a voltage of 5 copies of mixed ionic solutions was no-voltage, −0.1 V, −0.2 V, −0.3 V and −0.4 V, respectively, an adsorption time was 2 h, and the electrolyte solution before and after the adsorption was 0.5 mL;

a preparation method of the tannic acid@graphene oxide conductive aerogel is as follows: 2.5 mL of graphene oxide dispersion liquid was uniformly mixed with 1 mL of tannic acid aqueous solution, ultrasonic dispersion was conducted for 20 min, then 1.5 mL of deionized water was added, ultrasonic dispersion was conducted for 10 min, the mixture was put into an oven for incubation at 90° C. for 20 h, then taken out from the oven, and stood and soaked in deionized water, the deionized water was changed every 30 min for standing and soaking for 30 min until the aqueous solution changed from light yellow to colorless and transparent to wash off excess tannic acid, and finally the tannic acid@graphene oxide conductive aerogel was obtained by freeze-drying for 24 h;

where a concentration of the graphene oxide dispersion liquid was 4 mg/mL, and a solvent was deionized water; and

a concentration of the tannic acid aqueous solution was 10 mg/mL;

thirdly, the selectivity coefficient of the adsorbent for adsorbing lead ions was calculated, where the selectivity coefficient calculation formula is as follows:

$${k}_{d} = \frac{( {C}_{0} - {C}_{e} ) V}{{mC}_{e}} \qquad ( 1 )$$

k_{d}: the separation coefficient of adsorbent for different metal ions (L/mg);

C₀: the initial concentration of metal ions (mg/L);

Cₑ: the concentration of metal ions after adsorption for 2 h (mg/L);

V: the volume of the initial mixed ionic solution (L);

m: the mass of the adsorbent (tannic acid@graphene oxide conductive aerogel) (g);

$$k = \frac{{k}_{{d}_{1}}}{{k}_{{d}_{2}}} \qquad ( 2 )$$

k: the selectivity coefficient of the adsorbent for lead ions;

k_{d1}: the separation coefficient of the adsorbent for lead ions;

k_{d2}: the separation coefficient of the adsorbent for remaining metal ions.

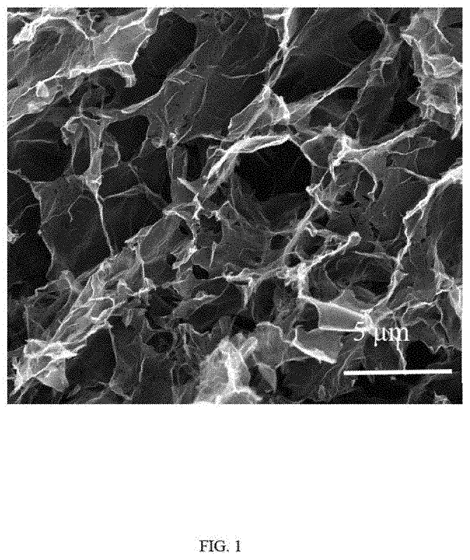

FIG. 1 shows an SEM image of tannic acid@graphene oxide in step 1 of Experiment 1. As can be seen from the image, tannic acid and graphene oxide are mutually cross-linked to form a three-dimensional porous structure with rough surface and more adsorption sites, which is favorable for adsorption of heavy metal ions by the material.

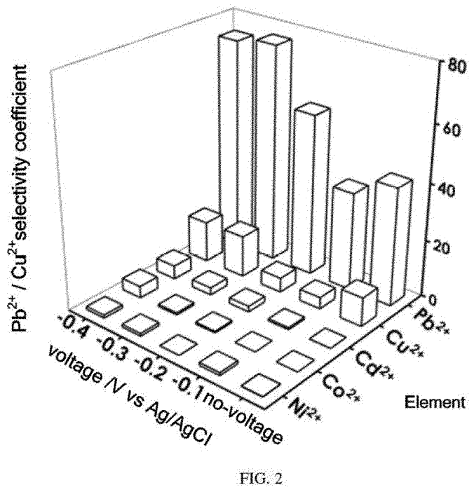

FIG. 2 shows a graph of adsorption capacity data of tannic acid@graphene oxide conductive aerogel for each metal ion in a mixed ion solution under different electric field conditions in Experiment 1. As can be seen from the graph, in the absence of voltage, the adsorbent has the maximum adsorption capacity for lead ions among the five metal ions, and also has a certain adsorption effect for copper ions. As an applied voltage is increased, the adsorption capacity of the adsorbent for lead ions is generally increased, and the adsorption of copper ions is inhibited under the conditions of −0.1 V and −0.2 V.

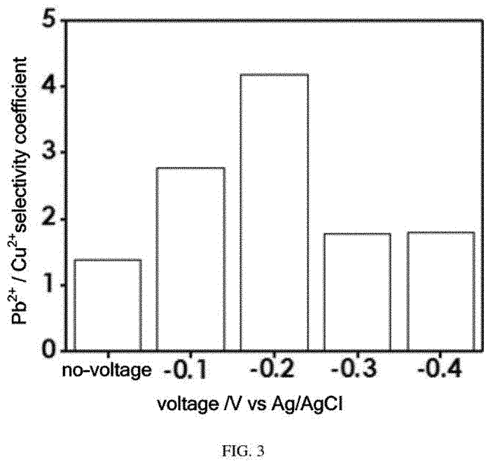

FIG. 3 shows a graph of selectivity coefficient data of tannic acid@graphene oxide conductive aerogel for lead over copper ions under different electric field conditions in Experiment 1. As can be seen from the graph, the adsorbent has the maximum selectivity to lead ions under a voltage of −0.2 V, mainly because lead ions migrate to the surface of the adsorbent more easily under a voltage of −0.2 V, which accelerates the adsorption process, thereby increasing the selectivity of the adsorbent to lead ions. However, when a voltage is greater than −0.2 V, the migration rate of copper ions is also enhanced, so that the adsorption rate of copper ions is enhanced (see FIG. 2), resulting in a decrease in the selectivity coefficient of the adsorbent for lead ions. Therefore −0.2 V is the optimal voltage to enhance the selectivity coefficient of tannic acid@graphene oxide conductive aerogel for lead ions.

Experiment 2: the experiment verified the influence of tannic acid@graphene oxide conductive aerogel on adsorption selectivity for lead ions at different electroreduction time, including the following steps:

firstly, an electrochemical adsorption was conducted (with an electrochemical working station CHI760E from Shanghai CH Instruments Co., Ltd.) in a sodium nitrate electrolyte solution by a current-time method, with a three-electrode system composed of the tannic acid@reduced graphene oxide conductive aerogel as a working electrode, Ag/AgCl as a reference electrode and platinum mesh as a counter electrode, and the tannic acid@reduced graphene oxide conductive aerogel in different reduction states was obtained; where an applied voltage was −1.2 V, a reduction time for 6 groups of experiment was 0 min, 2 min, 5 min, 10 min, 20 min, and 30 min respectively, and a concentration of the sodium nitrate aqueous solution was 0.5 mol/L;

a preparation method of the tannic acid@graphene oxide conductive aerogel is as follows: 2.5 mL of graphene oxide dispersion liquid was uniformly mixed with 1 mL of tannic acid aqueous solution, ultrasonic dispersion was conducted for 20 min, then 1.5 mL of deionized water was added, ultrasonic dispersion was conducted for 10 min, the mixture was put into an oven for incubation at 90° C. for 20 h, then taken out from the oven, and stood and soaked in deionized water, the deionized water was changed every 30 min for standing and soaking for 30 min until the aqueous solution changed from light yellow to colorless and transparent to wash off excess tannic acid, and finally the tannic acid@graphene oxide conductive aerogel was obtained by freeze-drying for 24 h;

secondly, 15 mL of mixed ion solution was prepared in 6 copies; the mixed ion solution contained metal ions Pb²⁺, Cu²⁺, Cd²⁺, Co²⁺ and Ni²⁺, and a concentration of each metal ion was 1 mmol/L;

an electrochemical adsorption was conducted (with an electrochemical working station CHI760E from Shanghai CH Instruments Co., Ltd.) in a 6 copies of mixed ion selectrolyte solution by a current-time method, with a three-electrode system composed of the tannic acid@reduced graphene oxide conductive aerogel in 6 different reduction states prepared in step 1 as a working electrode, Ag/AgCl as a reference electrode and platinum mesh as a counter electrode, and the lead element was recovered on the working electrode, where a voltage was −0.2 V, and an adsorption time was 2 h; 0.5 mL of the electrolyte solution before and after adsorption was taken, the change of a concentration of each metal ion in the electrolyte solution before and after adsorption was measured with an atomic absorption spectrometer, and the selectivity coefficient was calculated.

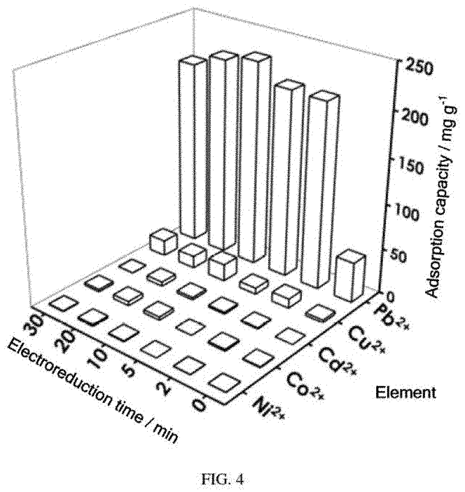

FIG. 4 shows a graph of adsorption capacity data of tannic acid@graphene oxide conductive aerogel for heavy metal ions in different reduction states under an electric field of −0.2 V in Experiment 2. As can be seen from the graph, after the reduction in step 1, the adsorption amount of tannic acid@graphene oxide conductive aerogels for lead ions is greatly increased while almost no obvious enhancement is observed on other ions. This is because the longer a reduction time, the better the conductivity of the tannic acid@graphene oxide conductive aerogel, and the more obvious the enhancement of the adsorption performance of lead ions under a voltage condition of −0.2V in step 2.

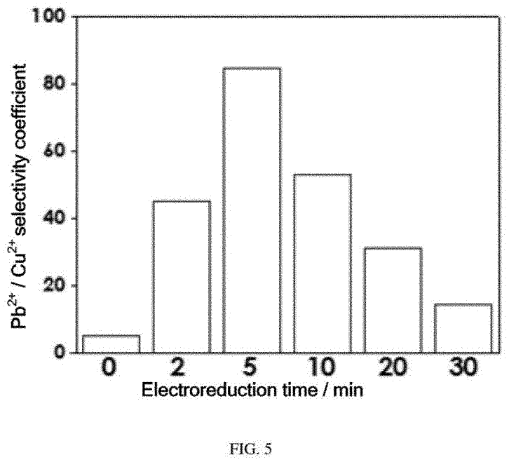

FIG. 5 shows a graph of selectivity coefficient data of tannic acid@graphene oxide conductive aerogel for lead over copper ions in different reduction states at a voltage of −0.2 V in Experiment 2. As can be seen from a comparison between FIG. 5 and FIG. 3, the selectivity of the adsorbent to lead ions is increased significantly after the reduction in step 1. This is because as a reduction time increases, the conductivity of the tannic acid@graphene oxide conductive aerogel gradually increases, resulting in the electric field more easily accelerating the migration rate of lead ions and enhancing the selectivity of the material for the adsorption of lead ions. However, when a reduction time is greater than 5 min, the selective effect of the electric field on the adsorption of lead ions begins to decrease, which is mainly due to the fact that as the conductivity of the material increases, the ability of the electric field to adsorb copper ions will also increase, resulting in a decrease in the selectivity to lead ions. Therefore, the tannic acid@graphene oxide conductive aerogel reduced for 5 min in step 1 is the optimal conductive adsorption material.

What is claimed is:

1. A method for selective adsorption of lead ions from heavy metal wastewater by electric field enhancement, wherein the method comprises:
in a first step (“step 1”), conducting an electroreduction process in a sodium nitrate electrolyte solution by a current-time method, with a three-electrode system composed of tannic acid@graphene oxide conductive aerogel as a working electrode, Ag/AgCl as a reference electrode, and platinum mesh as a counter electrode, and obtaining tannic acid@reduced graphene oxide conductive aerogel; wherein a voltage applied to the working electrode is −1.2 V to −2 V, a reduction time is 2 min to 30 min, and a concentration of the sodium nitrate aqueous solution is 0.5 mol/L to 0.6 mol/L; and
in a second step (“step 2”), conducting an electrochemical adsorption in a lead ions-containing heavy metal wastewater electrolyte solution by a current-time method, with a three-electrode system composed of the tannic acid@reduced graphene oxide conductive aerogel prepared in step 1 as a working electrode, Ag/AgCl as a reference electrode, and platinum mesh as a counter electrode, and recovering lead element on the working electrode, wherein a voltage applied to the working electrode in the second step is −0.1 V to −0.2 V, and an adsorption time is 2 h to 2.5 h.

2. The method for selective adsorption of lead ions from heavy metal wastewater by electric field enhancement according to claim 1, wherein a preparation method of the tannic acid@graphene oxide conductive aerogel in step 1 comprises:
mixing 2.5 mL of graphene oxide dispersion liquid with 1 mL of tannic acid aqueous solution uniformly, conducting ultrasonic dispersion for 20 min, then adding 1.5 mL of deionized water, conducting ultrasonic dispersion for 10 min, putting the mixture into an oven for incubation at 90° C. for 20 h, then taking out the mixture from the oven, standing and soaking the mixture in deionized water, changing the deionized water every 30 min for standing and soaking for 30 min until the aqueous solution changed from light yellow to colorless and transparent to wash off excess tannic acid, and finally obtaining the tannic acid@graphene oxide conductive aerogel by freeze-drying for 24 h;
wherein a concentration of the graphene oxide dispersion liquid is 4 mg/mL, and a solvent is deionized water; and
a concentration of the tannic acid aqueous solution is 10 mg/mL.

3. The method for selective adsorption of lead ions from heavy metal wastewater by electric field enhancement according to claim 1, wherein the electrochemical workstation CHI760E is used for the electroreduction process by a current-time method in step 1.

4. The method for selective adsorption of lead ions from heavy metal wastewater by electric field enhancement according to claim 1, wherein the applied voltage in step 1 is −1.2 V, and the reduction time is 5 min.

5. The method for selective adsorption of lead ions from heavy metal wastewater by electric field enhancement according to claim 1, wherein the electrochemical workstation CHI760E is used for the electrochemical adsorption by a current-time method in step 2.

6. The method for selective adsorption of lead ions from heavy metal wastewater by electric field enhancement according to claim 1, wherein the voltage in step 2 is −0.2 V and the adsorption time is 2 h.
